(19) United States
(12) Patent Application Publication
(10) Pub. No.: US 2011/0161819 A1
(43) Pub. Date: Jun. 30, 2011

(54) VIDEO SEARCH SYSTEM AND DEVICE

(75) Inventor: CHAO-TSUNG FAN, Tu-Cheng (TW)

(73) Assignee: HON HAI PRECISION INDUSTRY CO., LTD., Tu-Cheng (TW)

(21) Appl. No.: 12/689,186

(22) Filed: Jan. 18, 2010

(30) Foreign Application Priority Data
Dec. 31, 2009 (TW) 98146085

(51) Int. Cl. G06F 3/00

(52) U.S. Cl. 715/721

(57) ABSTRACT

A video search device is provided to quickly obtain desired video segments. A video search system of the video search device sequentially reads an audio file and a video file from first predetermined time, and determines whether an intensity of audio signals of the audio file is greater than a predetermined value. An audio signal time position of the audio file is determined to be an index time for searching a desired video segment in response so that the intensity of the audio signal is greater than the predetermined value. The video search system selects a segment of videos of the video file as the desired video segment during a period of second predetermined time based on the index time of the audio file, and stores the desired video segment.

### BACKGROUND

1. Technical Field

The present disclosure relates to a video search device, system, and a method for providing desired video segments.

2. Description of Related Art

Surveillance systems including many video security cameras are widely used to monitor areas of interest. The surveillance systems depend on video tracking as a means for alerting the operators. Videos captured can provide time, duration, file type, images or other germane information for users or analysts to conveniently examine and obtain desired video segments, for example, correlating incidents, time, and/or subjects' faces. However, viewing an entire video file just to obtain such specific data is inefficient and inconvenient.

### BRIEF DESCRIPTION OF THE DRAWINGS

FIG. 1 is a schematic view of an exemplary embodiment of a video search device.

FIG. 2 is a block diagram of an exemplary embodiment of a video search system.

FIG. 3 is a schematic view showing videos and audio signal waveforms recorded by the video search system of FIG. 2.

FIG. 4 is a flowchart of an exemplary embodiment of a video search method.

### DETAILED DESCRIPTION

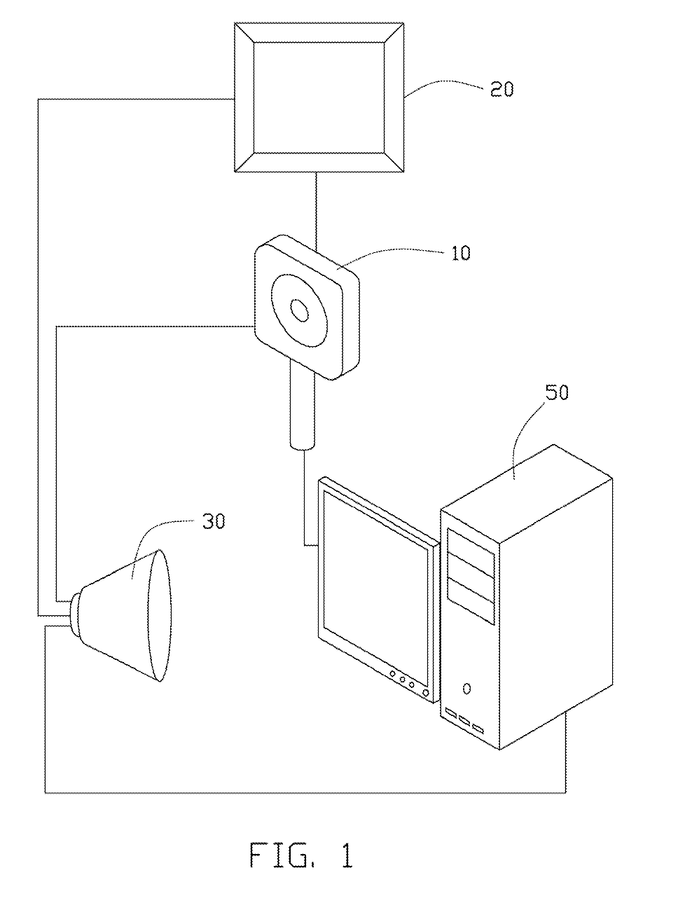

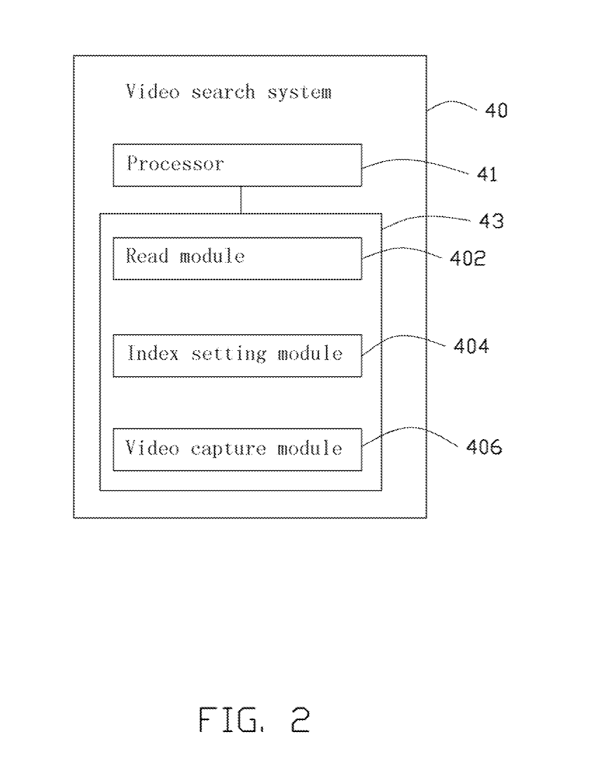

Referring to FIGS. 1 to 3, an exemplary embodiment of a video search device that can quickly obtain desired video segments from a video file. In one embodiment, the video search device may be installed at an entrance for image recording. The video search device includes a monitoring device 10, a sensor 20, a buzzer 30, and a computer 50. The sensor 20, the buzzer 30, and the computer 50 are connected to the monitoring device 10. The buzzer 30 is also connected to the sensor 20 and the computer 50. In this embodiment, the monitoring device 10 may be a camera, or another kind of video-taking device, and a video search system 40 is located in the computer 50. In other embodiments, the sensor 20 and the buzzer 30 can also be arranged inside the monitoring device 10.

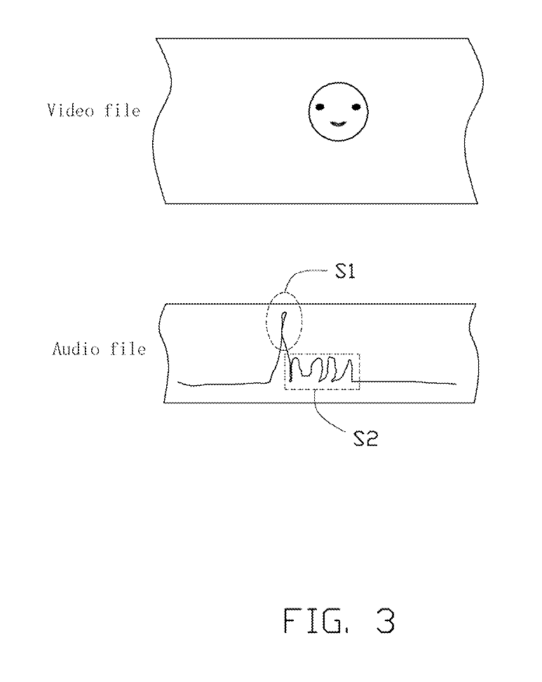

The monitoring device 10 may be installed at an entrance to provide timely capturing of the location in video and audio files to be stored in the computer 50. The sensor 20 senses acoustic environmental conditions (e.g., a groan, door or floor squeak), triggering the buzzer 30 sound (e.g., a beep or ding-dong) after the entrance is accessed, opened for a period, or breached. Thereupon, the monitoring device 10 can capture face or faces of any person or persons present who may have triggered the buzzer 30. Due to its high frequency sound, intensity of audio signals from the buzzer 30 (e.g., a segment of waveform S1, shown in FIG. 3) is greater than intensity of the audio signal from normal environments. In detail, intensity of audio signals of an environment (e.g., a segment of waveform S2, shown in FIG. 3) is lower when there is a person occupying space in or around the entrance thus blocking other sounds. Intensity of the audio signals of the environment is lowest when no one is passing through the entrance. The audio file and the video file correspond to each other in an order of time as shown in FIG. 3. In this embodiment, a time length of each of the audio file and video file is 2 hours.

The video search system 40 includes a processor 41 and a memory 43. The processor 41 is connected to the memory 43. The memory 43 includes a read module 402, an index setting module 404, and a video capture module 406, each of which stores one or more computerized instructions for the processor 41.

The read module 402 sequentially reads the audio file, the video file, and end time (e.g., a maximum time) of the audio file and the video file from first predetermined time stored in the computer 50, and determines whether the first predetermined time is greater than the end time of the audio file.

The index setting module 404 determines whether an intensity of the audio signals of the audio file is greater than a predetermined value (e.g., 60 decibels), and that the first predetermined time is less than the end time of the audio file. If the intensity of an audio signal is greater than the predetermined value, the audio signal time position of the audio file is determined to be an index time for searching desired video segment. In the embodiment, the index time is at an initial position to search the desired video segment.

The video capture module 406 selects a segment of videos of the video file as a desired video segment within a period of second predetermined time which is after the index time of the audio file, and stores the desired video segment. The video capture module 406 adds the index time to third predetermined time to obtain a new time as the first predetermined time to search a next desired video segment.

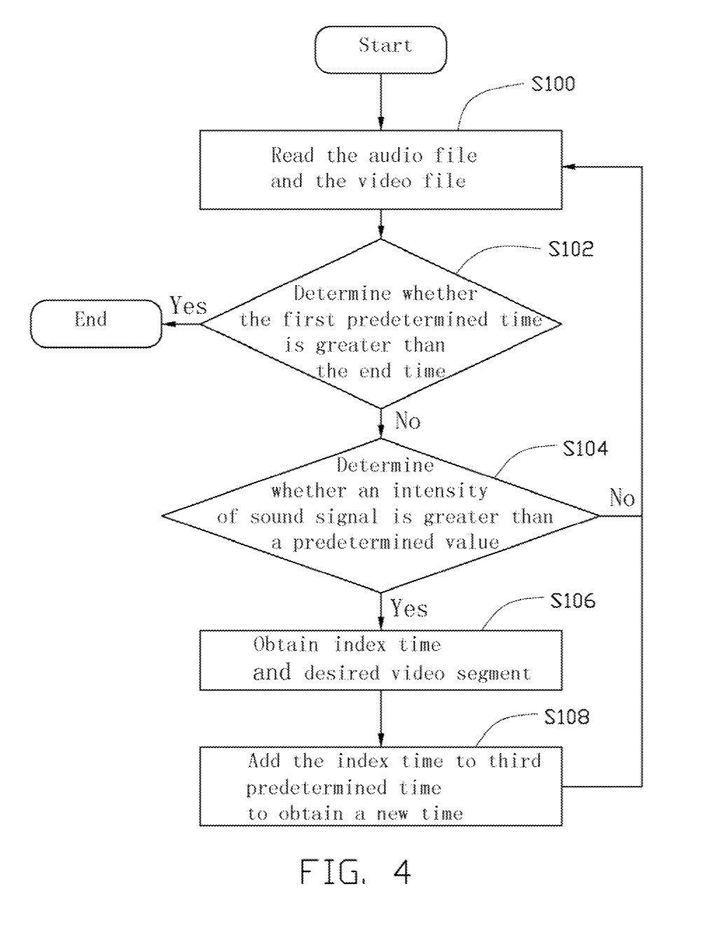

FIG. 4 is a flowchart of an exemplary embodiment of a video search method. The method includes the following steps.

In step S100, the read module 402 sequentially reads the audio file, the video file, and end time of the audio file and the video file from first predetermined time stored in the computer 50. At the beginning, the read module 402 reads from beginning time of the audio file.

In step S102, the read module 402 determines whether the first predetermined time is greater than the end time of the audio file. If the first predetermined time is greater than the end time of the audio file, the procedure ends. If the first predetermined time is less than the end time of the audio file, the procedure goes to step S104.

In step S104, the index setting module 404 determines whether an intensity of an audio signal of the audio file in the first predetermined time is greater than a predetermined value (e.g., 60 decibels). If the intensity of an audio signal is greater than the predetermined value, the procedure goes to step S106. If the intensity of an audio signal is less than or equal to the predetermined value, the procedure returns to step S100.

In step S106, the audio signal time position of the audio file is determined to be an index time for searching desired video segment, the video capture module 406 selects a segment of videos of the video file as desired video segment within a period of second predetermined time which is after the index time of the audio file, and stores the desired video segment.

In step S108, the video capture module 406 adds the index time to third predetermined time to obtain a new time as the first predetermined time, and the procedure returns to step S100.

In other embodiments, the audio file and the video file can also form one file, the buzzer 30 can also be omitted, the index time can be determined based on environmental sounds, and the video capture module 406 can select desired video segment as needed, for example, the videos are selected as desired video segment during a period of second predetermined time within or before the index time of the audio file.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A video device comprising:
a monitoring device to capture a location as a video file and an audio file corresponding to the video file in an order of time; and
a video search system to sequentially read the audio file and the video file, determine whether an intensity of audio signals of the audio file is greater than a predetermined value, wherein an audio signal time position of the audio file is recorded as an index time for searching a desired video segment in response to the intensity of the audio signal being greater than the predetermined value, the video search system selects a segment of videos of the video file as the desired video segment within a period of predetermined time based on the index time of the audio file.

2. The device of claim 1, further comprising a sensor and a buzzer, wherein the monitoring device is installed at the location, the sensor senses acoustic environmental conditions triggering the buzzer sound after the location is disturbed acoustically for a period.

3. The device of claim 1, wherein the video search system selects the segment of videos of the video file as the desired video segment within the period of predetermined time which is after the index time of the audio file.

4. The device of claim 1, wherein the monitoring device is a camera.

5. A video search system comprising:
a processor and a memory connected to the processor, the memory comprising a plurality of modules each of which stores one or more computerized instructions being executed by the processor, wherein the plurality of modules comprises:
a read module to sequentially read an audio file and a video file from first predetermined time;
an index setting module to determine whether an intensity of audio signals of the audio file is greater than a predetermined value, an audio signal time position of the audio file is determined to be an index time for searching a desired video segment in response to the intensity of the audio signals being greater than the predetermined value; and
a video capture module to select a segment of videos of the video file as a desired video segment within a period of second predetermined time based on the index time of the audio file, store the desired video segment, and add the index time to third predetermined time to obtain a new time as the first predetermined time to search a next desired video segment.

6. The system of claim 5, wherein the video capture module selects the segment of videos of the video file as the desired video segment within the period of second predetermined time which is after the index time of the audio file.

7. A video search method comprising:
sequentially reading an audio file and a video file from first predetermined time;
determining whether the predetermined time is greater than end time of the audio file, the procedure ending in response to the predetermined time being greater than the end time of the audio file; and
determining whether an intensity of audio signal of the audio file is greater than a predetermined value in response to the predetermined time being not greater than the end time of the audio file, determining an audio signal time position of the audio file to be an index time for searching desired video segment, selecting a segment of videos of the video file as a desired video segment within a period of second predetermined time which is after the index time of the audio file, and storing the desired video segment in response to the intensity of the audio signal of the audio file being greater than the predetermined value; and
adding the index time to third predetermined time to obtain a new time as the first predetermined time, and returning to the step of sequentially reading an audio file and a video file from first predetermined time.

8. The method of claim 7, wherein the segment of videos of the video file is selected as the desired video segment within the period of second predetermined time which is after the index time of the audio file.
